(19) United States
(12) Patent Application Publication
(10) Pub. No.: US 2005/0197893 A1
(43) Pub. Date: Sep. 8, 2005

(54) Coupon, price-comparison, and product-review information toolbar for use with a network browser or system/application interface

(76) Inventors: Michael Landau, Greenbrae, CA (US); Evan Horowitz, San Francisco, CA (US)

Correspondence Address: PERKINS COIE LLP, P.O. BOX 2168, MENLO PARK, CA, 94026, US

(21) Appl. No.: 10/786,904

(22) Filed: Feb. 24, 2004

(51) Int. Cl. G06F 17/60

(52) U.S. Cl. 705/14

(57) ABSTRACT

A system, method, and computer program product are provided for affording coupon, price-comparison, and/or product-review information utilizing a toolbar within a browser or system/application interface. In response to a request for such information, the invention is able to auto-detect the merchant and/or product to search for without further user input. Relevant information is returned and displayed for the requester in a small companion window or is displayed seamlessly in the browser or interface.

### BACKGROUND OF THE INVENTION

1. Field of the Invention

The present invention relates to e-commerce and network browsers. In particular, the present invention teaches an interface for auto-detecting coupon, price-comparison, and/or product-review information while shopping online.

E-Commerce

One of the most popular features of the Internet is the ability to conduct e-commerce transactions, e.g., online shopping. With the advent of sophisticated websites and online “shopping carts,” consumers are typically able to save time and money by shopping online. At this time, a high percentage of pre-Internet retailers have websites that allow purchases over the Internet. In addition, the Internet has spawned many new retail companies that did not exist previously, such as Amazon.com. It is also very commonplace for these websites to have the ability to redeem coupons or receive discounts for purchases.

Price-Comparison Services, Product-Reviews & Coupon Databases

Another consequence of the Internet is the flood of available information resulting from the “community” nature of websites. This has recently led to websites that provide price-comparison services and/or coupon information and/or product-reviews. There are a number of services that use automated agents or databases to collect and display price comparisons or product reviews based on search criteria that a user enters. Additionally, coupon “search engines” exist that allow a user search a database or access a directory of coupon “codes” or offers. Most of these search engines allow a user to search for a particular merchant or product category.

Typically consumers can either a) click on a link to receive a discount or activate the coupon, b) enter a special code at the website to receive a discount or activate the coupon, or c) print out the coupon for use at a physical store location.

2. State of the Art

Current implementations of the above services lack a crucial interface for better integration, convenience and ease of use. In particular, current interfaces require a user to leave the current browser environment and manually input information to facilitate the search for coupons, price-comparisons, and/or product-reviews.

Browsers and Toolbars

The most common type of browser is a computer application used for navigating the Internet. Some of the more popular browsers include Microsoft's Internet Explorer, Netscape's Navigator, and Apple's Safari. However, browsers also function as interfaces to other types of systems and applications, apart from the Internet. For example, the interface that allows one to navigate through the local file system on a personal computer in order to “browse” the computer's contents is also a type of browser.

Many browsers have features that allow a user to “bookmark” locations in order to facilitate repeated visits to that location. Toolbars are more sophisticated implementations of bookmarks, frequently with expanded functionality and customizability. Typically toolbars are either 1) integrated or built-into the browser, 2) installed as a “plug-in” that expands the capability of the browser, or 3) placed on the toolbar in a manner similar to “bookmarking” or “dragging-and-dropping”. Bookmarks with functionality beyond simple “linking” to other web sites are sometimes referred to as “bookmarklets.”

In the past, browser toolbars have mainly been used for navigating the Internet, searching for general information, and providing other generic features such as simple links to other web sites. Recently, companies such as Google, Alexa and Yahoo have created their own private-branded toolbars that provide expanded search and web-browsing functionality. But until now, no prior art browser toolbars have been used to specifically provide coupon, price-comparison, and/or product-review information via environment-aware functions.

### BRIEF DESCRIPTION OF THE DRAWINGS

The invention, together with further advantages thereof, may best be understood by reference to the following description taken in conjunction with the accompanying drawings in which:

FIG. 1 is a suitable embodiment of the invention;

FIG. 2 is an illustration of the invention and it's usage within a network browser.

### SUMMARY OF THE INVENTION

According to the invention, a user requests coupon, price-comparison, and/or product-review information relating to the Internet web site and/or product the user is currently viewing. Next, the invention automatically detects the Internet web site and/or product the user is currently viewing. Further, the invention attempts to retrieve relevant stored coupon, price-comparison, or product-review information from a database. Finally, the information is formatted and displayed for the user. Information from external sources and links to other sources of data and services are also displayed. Additional functionality allows for customization and added convenience.

The present invention is able to auto-detect or automatically infer such information, and upon a user request, respond with relevant information in a format and manner that enhances, and does not interfere with, the shopping experience.

Having the functionality of the invention available in a toolbar setting provides many advantages for the user. First, the prominent location of the toolbar acts as a subtle reminder to check for discounts before finalizing an online purchase. Second, there is no need for the user to leave their current location to go searching for appropriate coupons or other information. Instead, the information is brought to the user in a convenient and functional interface.

In addition, the invention allows for other user functions such as:
Easy Activation of Coupons or Discounts.
Specific User Preferences.
Suggested Coupons, Merchants, or Products.
Desktop Toolbar Access.
Search Engine for Coupons, Merchants, or Products.
   A suitable embodiment of the invention may be found at: http://www.coupontoolbar.com

### DETAILED DESCRIPTION OF THE INVENTION

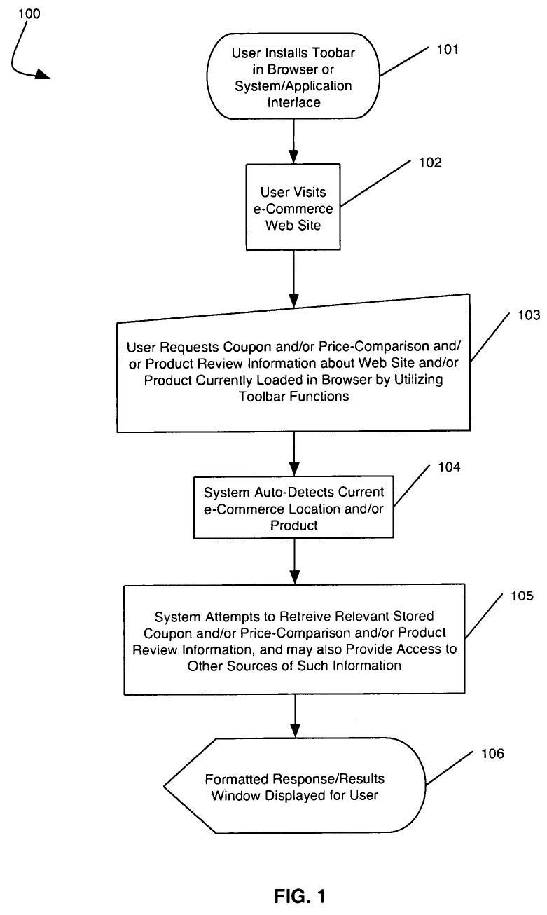

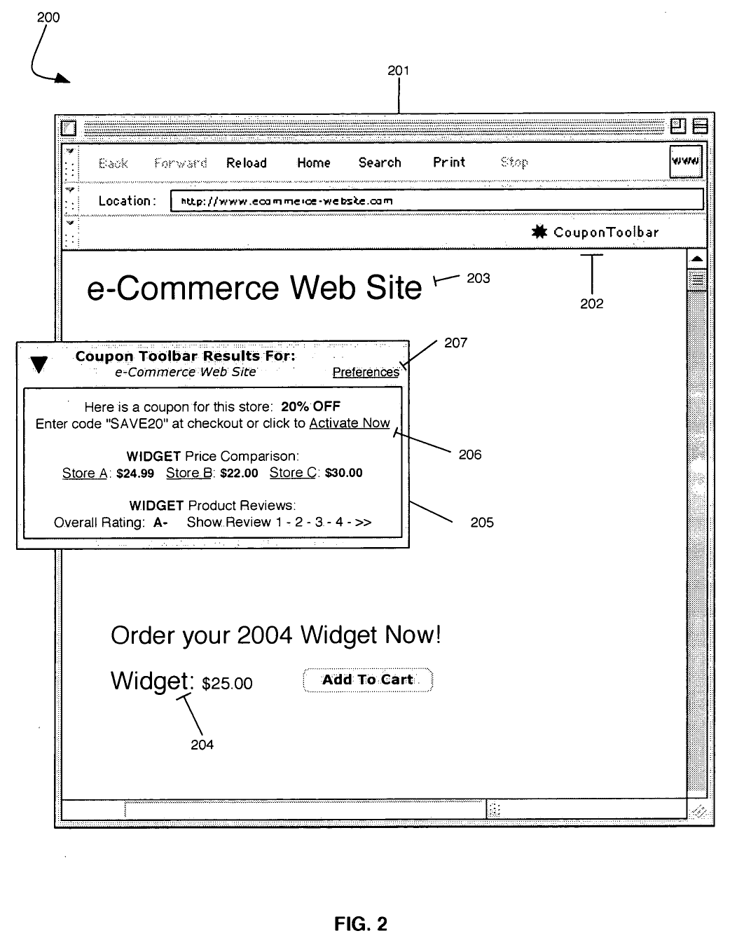

FIGS. 1 and 2 demonstrate suitable embodiments of the invention. FIG. 1 illustrates a flow chart of a method 100 in accordance with one aspect of the present invention. FIG. 2 illustrates a window 200 showing an interface according to one embodiment of the present invention. According to the method 100, the user installs the invention or it comes pre-installed in a network browser or system/application interface at a step 101. In FIG. 2, a typical installed version of the invention is found at button 202 in network browser, 200 and 201. Other types of installations and pre-installations will be apparent to those skilled in the art.

In a step 102, a user visits an online shopping establishment in step 102. In window 200 of FIG. 2, this is represented at 203 where the user views a specific merchant website. In a next step 103, the user initiates a request for coupon, price-comparison, and/or product-review information. In FIG. 2, this request is represented at button 202 where the user may push the “Coupon Toolbar” button to initiate a request via step 103. Other methods of initiating the request for information will be apparent to those skilled in the art.

In step 104, the system is able to detect the location, merchant and/or product that the user is currently visiting or viewing at step 102 and window 203 at the time request step 103 is made. At least two methods for performing this detection are contemplated. Both methods require the ability to discern the web address or URL (Uniform Resource Locator) that the user is currently viewing/visiting. Once the URL is known, it can be analyzed to determine the domain name, and once the domain is known, the system is able to correlate the domain to a particular merchant or location. Alternatively, and for a more thorough and detailed analysis of the user's current environment, the system at a step 104 can attempt to access the actual content of the URL the user is viewing. The system may then look for keywords or specific content or formatting to make determinations about the user environment. For example, if a merchant consistently includes the name of the product in a certain place in the HTML, the invention can be configured to automatically retrieve that information from that merchant. Thus the invention is able to determine the product being viewed by the user. Other methods of automatically detecting relevant information from the user's environment will be apparent to those skilled in the art.

At a step 105, after detecting environmental information, the method 100 attempts to retrieve relevant stored information from a database within the system. The method 100 may also provide access to, or respond with, relevant information from external sources.

Finally, at a step 106, the formatted information is displayed for the user. In FIG. 2, this is represented at window 205 where a small information window appears in the user's environment with relevant data in response to the request of step 103. Other methods of displaying and formatting internal and external information for users will be apparent to those skilled in the art.

In summary, the features of FIG. 2 can be described as follows:
201 illustrates the user's network browser window which is being used for Internet navigation.
202 illustrates a button on the toolbar that initiates a request for information from the invention.
203 illustrates the user's current e-commerce location on the Internet.
204 illustrates the specific product information associated with the user's current e-commerce location on the Internet.
205 illustrates a results window of relevant information returned by the invention.
206 illustrates an auto-activation or auto-fill mechanism for use in the invention.
207 illustrates a preferences mechanism for users to customize their experience with the invention.

Other features for added functionality and convenience for users will be apparent to those skilled in the art.

1. A method for providing commercial information such as coupon, rebate, price-comparison, or product-review services and information, utilizing a toolbar within a network browser or system interface computing environment, comprising:
(a) receiving a request for said commercial information via said toolbar;
(b) automatically detecting information about a specific merchant and/or product from within the browser or interface environment;
(c) retrieving relevant stored information about the detected information; and
(d) displaying formatted information to the requesting entity.

2. A method as recited in claim 1, further including utilizing the toolbar in manner selected from the following list:
(a) as a built-in or integrated feature of a network browser or system interface;
(b) as a plug-in or expandable feature of a network browser or system interface;
(c) as a button, linked or bookmarked feature of a network browser or system interface.

3. A method as recited in claim 1, further comprising:
receiving personal, preference or usage information associated with the requesting entity.

4. A method as recited in claim 3, further comprising:
providing or filtering services and information based on personal information, preferences or usage.

5. A method as recited in claim 1, further comprising:
providing access to internal and external sources of such services and information.

6. A method as recited in claim 1, further comprising:
utilizing the information and services in conjunction with a search engine interface.

7. A method as recited in claim 1, further comprising:
an auto-activation and/or auto-fill function to automatically enter or transmit coupon information to a merchant web site.

8. A system for providing coupon, rebate, price-comparison, or product-review services and information utilizing a toolbar within a network browser or system interface, comprising:
(a) means for receiving a request for such information;
(b) means for automatically detecting a specific merchant and/or product from the browser or interface environment;
(c) means for retrieving relevant stored information about the detected information;
(d) means for displaying formatted information to the requesting entity.

9. A system as recited in claim 8, further including means for utilizing the toolbar:
(a) as a built-in or integrated feature of a network browser or system interface;
(b) as a plug-in or expandable feature of a network browser or system interface;
(c) as a button, linked or bookmarked feature of a network browser or system interface.

10. A system as recited in claim 8, further comprising:
means for receiving personal, preference or usage information associated with the requesting entity.

11. A system as recited in claim 10, further comprising:
means for providing or filtering services and information based on personal information, preferences or usage.

12. A system as recited in claim 8, further comprising:
means for providing access to internal and external sources of such services and information.

13. A system as recited in claim 8, further comprising:
means for utilizing the information and services in conjunction with a search engine interface.

14. A system as recited in claim 8, further comprising:
means for an auto-activation and/or auto-fill function to automatically enter or transmit coupon information to a merchant web site.

15. A computer program embodied on a computer readable medium for providing coupon, rebate, price-comparison, or product-review services and information utilizing a toolbar within a network browser or system interface, comprising:
(a) a code segment for receiving a request for such information;
(b) a code segment for automatically detecting a specific merchant and/or product from the browser or interface environment;
(c) a code segment for retrieving relevant stored information about the detected information;
(d) a code segment for displaying formatted information to the requesting entity.

16. A computer program as recited in claim 15, further including a code segment for utilizing the toolbar:
(a) as a built-in or integrated feature of a network browser or system interface;
(b) as a plug-in or expandable feature of a network browser or system interface;
(c) as a button, linked or bookmarked feature of a network browser or system interface.

17. A computer program as recited in claim 15, further comprising:
a code segment for receiving personal, preference or usage information associated with the requesting entity.

18. A computer program as recited in claim 17, further comprising:
a code segment for providing or filtering services and information based on personal information, preferences or usage.

19. A computer program as recited in claim 15, further comprising:
a code segment for providing access to internal and external sources of such services and information.

20. A computer program as recited in claim 15, further comprising:
a code segment for utilizing the information and services in conjunction with a search engine interface.

21. A computer program as recited in claim 15, further comprising:
a code segment for an auto-activation and/or auto-fill function to automatically enter or transmit coupon information to a merchant web site.

22. A computer interface suitable for use as an Internet web browser, said computer interface comprising:
a coupon toolbar operable by a user of said Internet web browser; and
an autodetect process initiated by said coupon toolbar, said autodetect process responsive to a context of said Internet web browser at a time of initiation of said autodetect process to provide information related to an e-commerce transaction being considered by said user of said Internet web browser.

23. A computer interface as recited in claim 22, wherein said information related to said e-commerce transaction includes an electronic coupon for use by said user during said e-commerce transaction.

24. A computer interface as recited in claim 22, wherein said information related to said e-commerce transaction includes product information related to said e-commerce transaction.
